(19) United States
(12) Patent Application Publication
(10) Pub. No.: US 2006/0157581 A1
(43) Pub. Date: Jul. 20, 2006

(54) Three-way valves and fuel injectors using the same

(76) Inventors: Tibor Kiss, Manitou Springs, CO (US); Randall James Strauss, Colorado Springs, CO (US); James A. Pena, Encinitas, CA (US); John Mathew Quinlan, Woodland Park, CO (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/313,861

(22) Filed: Dec. 20, 2005

Related U.S. Application Data
(60) Provisional application No. 60/638,896, filed on Dec. 21, 2004.

(51) Int. Cl. F02M 47/02; F02M 63/00

(52) U.S. Cl. 239/88; 239/533.2

(57) ABSTRACT

Three-way valves having reduced leakage and fuel injectors using the same. Three-way spool poppet valves are disclosed having a spool with a poppet valve thereon cooperating with a seat on the valve housing to provide a substantially leak free valve closing in one direction characteristic of a poppet valve while preserving the advantages of a spool valve. Three-way ball valves are also disclosed having substantially leak free valves closing in both directions, but further including reduced short circuit losses due to direct flow from a high pressure source to a low pressure vent during transition of the ball from one position to the opposite position. Fuel injectors with direct needle control using the three-way valves of the present invention are also disclosed.

### CROSS-REFERENCE TO RELATED APPLICATION

This application claims the benefit of U.S. Provisional Patent Application No. 60/638,896 filed Dec. 21, 2004.

### BACKGROUND OF THE INVENTION

1. Field of the Invention

The present invention relates to the field of three-way valves, and fuel injectors using three-way valves.

2. Prior Art

Embodiments of the present invention provide improved devices for fluid control in various applications. A typical example is the control of a high pressure fuel injector. Typically, two-way poppet valves (open and closed) are used due to their superior leakage characteristics (low) and the ability to pressure balance a two-way poppet valve. It is highly desirable to use a three-way valve for improved performance and control, but this is difficult due to a three-way valve's inability to pressure balance completely unless it is a spool valve, which leaks excessively. For purposes of this disclosure, a three-way valve will be described as a valve coupling a source (S) passage to a control (C) passage or coupling the control passage to a vent (V), though other port identifications may be more appropriate depending on the use of the three-way valve.

The choices for a three-way valve are:

Spool valve. A spool valve can create the required hydraulic paths, but while in either position (S-C or C-V) the valve has a very short leak (seal) path from a high-pressure area to a vented area, which can lead to high system parasitic losses. This valve can be designed to have a hydraulic short circuit (momentarily coupling of source and vent when transitioning from one position to the other) or not, depending on the application. The advantages are primarily in its pressure balance, thereby requiring very low actuation forces, and in the ability to be designed to avoid the short circuit.

Three-way hard-seat valve (Poppet). This type of valve can have no leakage in either position, but when the valve is transitioning from one position to the other, there necessarily exists a direct flow path between the source and the vent that could lead to large losses of energy and system noise. This type of valve cannot be completely pressure balanced, and therefore requires more actuating forces than a typical pressure balanced spool valve.

Two two-way hard-seat valves (Poppet). This option has no leakage and can have a direct flow path between the source and the vent or not, depending on control of the system. The disadvantage of this system is that twice as many control valves are needed to achieve three-way control, adding system and control complexity, and further requires more room to package.

Thus the current choices and their disadvantages are:

Spool Valve: High static leakage.

Three-way hard-seat valve: High actuating force requirements (due to pressure imbalance) and short circuit loss.

Two, two-way hard seat valves: Cost and complexity.

Also known are three-way ball valves. Here a ball is moveable from one seat to an opposing seat, allowing fluid communication between a port at the side of the ball through whichever seat is uncovered by the ball. With the source of pressure through one seat and the control at the side of the ball and the vent through the other seat, there is a momentary flow path between the source and the vent during the transition of the ball from one seat to the other.

### BRIEF DESCRIPTION OF THE DRAWINGS

FIG. 1 is a cross-section of a three-way spool poppet valve in accordance with one embodiment of the present invention.

FIG. 2 is an illustration of the difference in mating angles of the spool poppet valve and respective poppet valve seat.

FIG. 3 is a cross-section of a three-way ball valve in accordance with another embodiment of the present invention.

FIG. 4 is a cross-section of an injector incorporating the three-way spool poppet valves and three-way ball valve of the present invention.

FIG. 5 presents the cross-section of the upper part of the injector of FIG. 4, taken on an expanded scale.

FIG. 6 presents the cross-section of the lower part of the injector of FIG. 4, taken on an expanded scale.

FIG. 7 illustrates a ball valve similar to that of FIGS. 3 and 4, though with a further improvement.

### DETAILED DESCRIPTION OF THE PREFERRED EMBODIMENTS

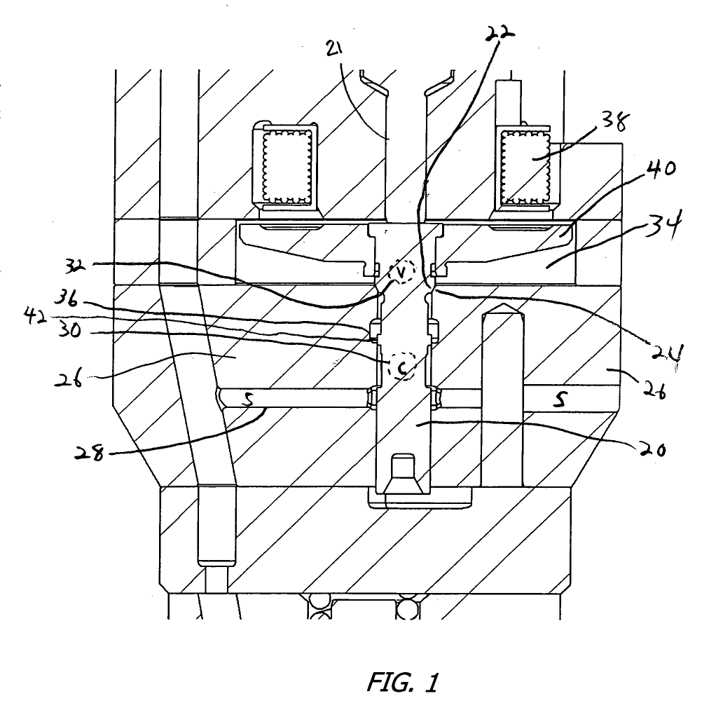

First referring to FIG. 1, a preferred embodiment of a three-way spool poppet valve in accordance with the present invention may be seen. The valve is comprised of a spool 20 having a poppet valve 22 at one end thereof, cooperating with a poppet valve seat 24 at the end of the spool valve housing 26. The valve itself is coupled to supply (S) port 28, a control (C) port 30, and a vent (V) port 32 that vents region 34 to a low pressure, which may or may not be equal to atmospheric pressure. The various ports are labeled as supply, control and vent, as one particular embodiment shown is used to control pressure over a hydraulic surface, in one case over the needle of a intensifier type fuel injector to provide direct needle control for the injector, and in another case to control pressure over a hydraulic actuator for a three-way ball valve. In other applications, more appropriate port identifications might be used. Also in FIG. 1, a groove 36 is provided in the spool housing, though is not coupled to any functional port.

In the position shown, the spool 20 is pushed downward by spring loaded or hydraulically actuated member 21 and is in its lowermost position, closing the poppet valve 22 against the poppet valve seat 24 at the upper region thereof. This prevents leakage of any fluid through the small gaps of the spool valve out that end to the vent. In this position, the spool 20 allows fluid communication between the supply port 28 and the control port 30, which in the direct injector needle control application, keeps the injector needle closed in spite of the intensified fuel pressure surrounding the needle.

In the embodiment shown, when solenoid coil 38 is activated, armature member 40 rises, pulling spool member 20 upward. During the first part of the upward movement of the spool 20, the poppet valve begins to open, even before the spool 20 moves upward far enough to close the flow path between the source port 28 and the control port 30. However during this time, land 42 blocks free communication between the control port 30 and the vent 32,34 until fluid communication between the source port 28 and the control port 30 is blocked by the spool valve. Then land 42 will move entirely into the vicinity of relief 36, now allowing free fluid communication between the control port 30 and the vent 32,34. Thus the three-way spool poppet valve of the present invention combines the leak-proof performance of a poppet valve with a spool valve, but at the same time eliminating the usual short circuit, that is, the momentary fluid communication between a source port and a vent port characteristic of a three-way poppet valve.

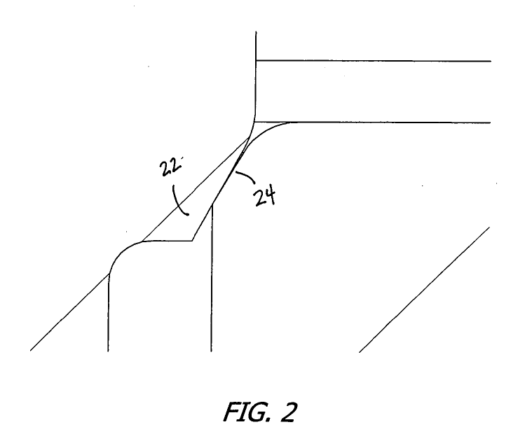

The spool poppet valve of the present invention will remain substantially pressure balanced even with a substantial pressure on the poppet valve itself. In particular, referring to FIG. 2, the angle on the poppet valve member 22 is slightly greater than the angle on the poppet valve seat 24. Consequently, sealing occurs at the diameter of the spool to preserve the pressure balance. Even with wear at the point of contact, sealing will occur substantially at that diameter to preserve the pressure balance.

Thus this embodiment of the invention creates a three-way hydraulic control valve using a unique combination of a poppet seat and a spool valve. The valve is normally on the poppet seat. On the guide portion of the valve, a port exists, creating a spool valve for the third way flow. Since the porting is arranged to flow from supply to control in this position, leakage is controlled by a long guide and the poppet seat and is therefore very low. Additionally (by way of another relief on the guide portion of the valve) this valve can now eliminate the hydraulic short circuit (HSC) of supply fluid to vent while the valve is transitioning from one position to the other (i.e. supply-control to control-vent). This is unique and beneficial also in the sense that the valve does not need to close on the poppet seat against flow across the poppet seat, as all flow to vent, other than spool valve leakage, is stopped by the spool valve. Thus this valve combines the advantages of a spool valve (low actuation forces due to pressure balance and possibility of no short circuit) with the advantages of a two-way poppet (pressure balance and low leak condition). Thus the valve requires low actuation forces due to pressure balance (for optimum packaging and low mass), low leakage and the option of no short circuit. This valve can therefore be a three-way valve used at very high pressures where a poppet valve is typically used, but only as a two-way. A pressure balanced, three-way, low leakage valve is highly desired for fuel system applications as one example, for direct control of needle motion in a diesel fuel injector.

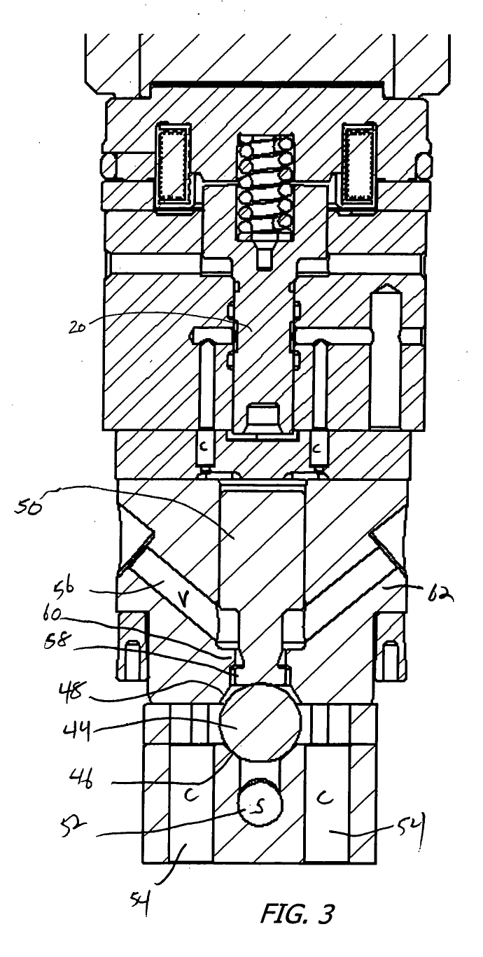

An alternate embodiment is shown in FIG. 3. In this Figure, parts with the same function as parts identified in FIG. 1 are identified with the same numerals, even though the configuration of the parts may differ. The ports source (S), control (C) and vent (v) are also labeled. The upper region 21 of spool 20 is relieved out of the plane of the cross-section to couple the control (C) to vent (V) when the spool 20 moves upward to open the poppet valve.

There are various ways of actuating the valves of the type represented in FIGS. 1 and 3. One is through an integrated magnetic end of the valve (20′ of FIG. 3). Another is with a separate armature 40 attached to the valve as in FIG. 1. In each case, the actuation can take place with one actuator and a spring return 21′ as in FIG. 3, or with two actuators, one for driving the valve in each direction. If electrically actuated, the valve requires little electric power, and in general is simple, has very high speed, and a low mass in a small package. The actuator could be, by way of example, solenoids of E-core or Pot-core configurations or mechanical or piezoelectric, to name a few. Also if desired, an O-ring could be used on the spool or in the spool housing opposite the poppet valve to prevent leakage at that location also.

Another form of novel three-way valve may be seen in FIG. 3. Here, a three-way ball valve is shown. Ball 44 is captured between two seats 46 and 48, being held against seat 46 by hydraulically actuated piston 50. Again using the same port designations, the high pressure supply (S) port 52 is below seat 46, the control (C) port 54 is adjacent the sides of the ball 44, and the vent (V) port 56 is above seat 48. With the ball in the position shown, the supply port is blocked and the control port and vent are in fluid communication. When the top of piston 50 is vented, the differential pressure between the supply pressure in port 52 and the vent 56 will push the ball upward to rest against seat 48 and seal port 56. Normally in a ball valve of this type, the ball motion is substantial in order to provide adequate flow passages from the open port around the ball, providing a substantial short circuit, i.e., time during which a substantial flow passage exists between the supply and the vent. In the novel ball valve of FIG. 3, piston 50 has an integral spool valve-like land 58 on its end which cooperates with the land 60 on the inside of body member 62. These perform like a normal spool valve, opening enough with the ball 44 in the lower position to provide an adequate flow passage between the control port 54 and the vent 56, but immediately beginning to close, and closing during the early part of the vertical motion of the ball to substantially limit the time and flow passage area during which the supply port 52 is in fluid communication with the vent port 56. Thus the short circuit characteristic of such ball valves is not eliminated, but its effect is substantially reduced, thereby substantially improving the performance of the valve. There are various ways of actuating the valve. The valve is not pressure balanced and therefore needs only to be actuated in one direction and will return to the original position once actuating force is removed. The actuating force could be generated by any of many different types of actuators, including hydraulic, magnetic and piezoelectric, hydraulic being shown in the fuel injector application herein described.

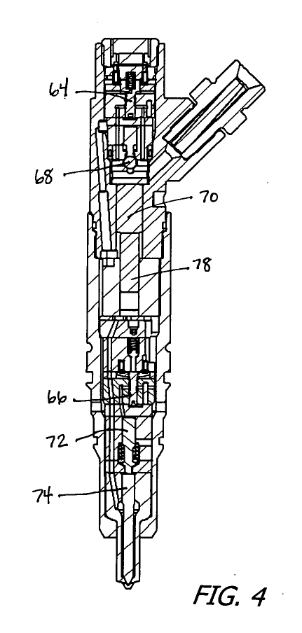

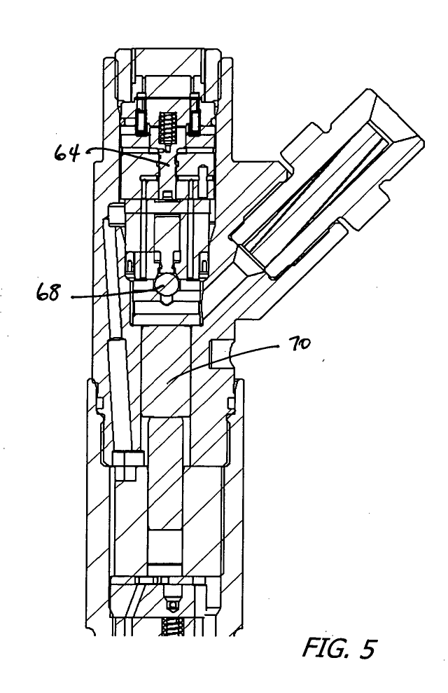

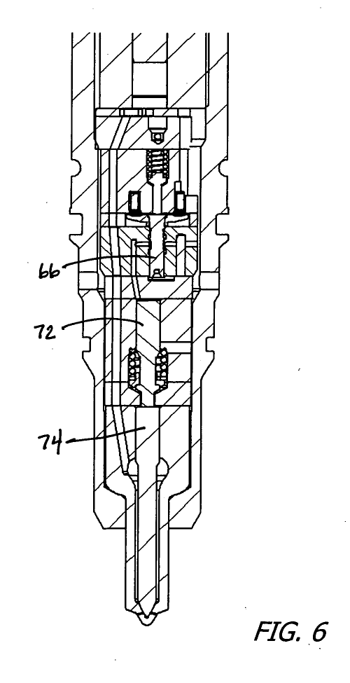

The valves of the present invention are well suited for various applications, one of which is in diesel fuel injectors. By way of example, FIG. 4 is a cross-section of an injector, with FIGS. 5 and 6 being cross-sections of the upper part and the lower part of the injector of FIG. 4, taken on a larger scale. Note that for clarity, FIGS. 5 and 6 each include a portion of the center of the injector. The injector shown is of the well-known intensifier type. It includes first and second three-way spool poppet valves 64 and 66 generally in accordance with FIGS. 3 and 1 of the present invention, and a three-way ball valve 68 also in accordance with FIG. 3 of the present invention. The three-way spool poppet valves are both electromagnetically actuated, though the two actuators are of somewhat different configurations, while the three-way ball valve is hydraulically actuated as in the embodiment of FIG. 3. Three-way spool poppet valve 64 controls pressure over the piston controlling the three-way ball valve 68 (see piston 50 in FIG. 3), that in turn controls pressure over the intensifier 70. Three-way spool poppet valve 66 provides direct needle control by directly controlling pressure over piston 72 in contact with the needle 74.

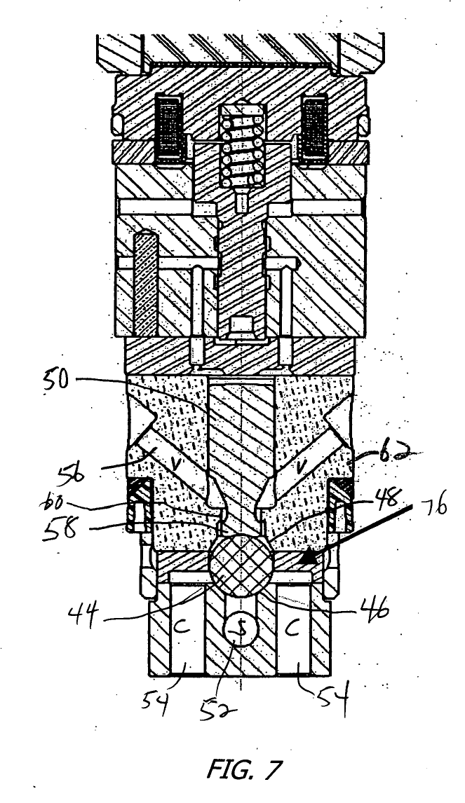

A further improvement on the ball valve 68 of FIGS. 3 and 4 may be seen in FIG. 7. This embodiment is similar to that of FIG. 3, and accordingly corresponding parts are similarly labeled. Like the embodiment of FIG. 3, this embodiment also incorporates integral spool valve-like land 58 on its end that cooperates with the land 60 on the inside of body member 62. As before, these perform like a normal spool valve, opening enough with the ball 44 in the lower position to provide an adequate flow passage between the control port 54 and the vent 56, but immediately beginning to close, and closing during the early part of the vertical motion of the ball to substantially limit the time and flow passage area during which the supply port 52 is in fluid communication with the vent port 56. Thus as before, the short circuit characteristic of such ball valves is not eliminated, but its effect is substantially reduced, thereby substantially improving the performance of the valve. In addition, however, in this embodiment orificed spacer 76 is added, defining a restricted flow path between the ball 48 and the orificed spacer 76. This restriction is chosen to allow adequate flow from ports 54 past the spool valve 58,60 to the vent ports 56 when the ball 44 is in the position shown in FIG. 7, but restricts flow from the source (S) port 52 to the vent ports 56 as the ball moves away from the position shown toward its opposite position. In that regard, note that the orificed spacer 76 does not restrict flow from the source (S) port 52 to the control (C) ports 54 when the ball 44 is in its upper most position. In the exemplary fuel injector application as described, the valve will spend most of the time in the position shown in FIG. 7, and exhibit very low leakage because of the ball 44 being forced onto the hard seat 46. For injection, the ball 44 will be forced upward against the hard seat 48 by the pressure from the source 52 and the lack of pressure over the hydraulically actuated piston 50, again exhibiting very low leakage. During movement of the ball from the position venting the ports 54 coupled to the region over the intensifier, as shown, to its upper most position, the less flow past the ball to the vent (V) the better, as that flow is from the undesired hydraulic short circuit from the source (S) directly to the vent (V). In fact, the flow restriction between the orificed spacer 76 and the ball 44 can be advantageous for the operation of the valve as the ball moves upward from the position shown, as the pressure drop caused by the restriction causes a greater differential pressure across the ball, helping to move the ball upward quickly and avoiding the initial high speed flow from the source (S) and the control (C) past the ball 44, holding the ball in close proximity to the seat 46 to restrict the flow from the source (S) to the control (C) during initiation of fuel intensification in the injector. On moving the ball 44 downward from its uppermost position to its lowermost position to stop intensification, the flow past the ball need only be enough to relieve the pressure on the intensifier in the injector and to allow the intensifier piston 70 and the intensifier plunger 78 (FIG. 4) to return to their uppermost positions between injection events. In the embodiment shown, the fuel rail pressure is provided under the intensifier plunger 78 to displace the fuel between injection events from over the intensifier piston 70 to vent. Accordingly, the flow rate between the ball 44 and the orificed spacer 76 need only be adequate to achieve this at any power and speed. Thus the orificed spacer defines a circular cylindrical restriction around the ball, restricting flow to the minimum allowable to achieve the function of the three-way valve.

Thus the three-way spool poppet valves disclosed herein provide a substantially leak proof valve when in one position, yet preserve the advantages of a three-way spool valve. The ball valves of the present invention provide a substantially leak proof valve when in either position, as is characteristic of ball valves, though further include means for minimizing the short circuit flow path from a high pressure source directly to a low pressure vent as the ball transitions from one position to the opposite position. These features are useful and advantageous in many applications, one of which is in fuel injectors, as also disclosed herein. Thus while certain preferred embodiments and applications of the present invention have been disclosed and described herein for purposes of illustration and not for purposes of limitation, it will be understood by those skilled in the art that various changes in form and detail may be made therein without departing from the spirit and scope of the invention.

What is claimed is:

1. A three-way valve comprising:
a valve body having a spool valve bore diameter with a poppet valve seat disposed at one end thereof;
a spool within the valve body, the spool having a poppet valve thereon, the spool being moveable within the valve body between a first position with the poppet valve positioned on the poppet valve seat and a second position with the poppet valve displaced from the poppet valve seat, the valve body and the spool defining a flow path between a first port in the valve body to a second port in the valve body when the spool is in the first position, and defining a flow path between the first port and the poppet valve seat and preventing flow between the first port and the second port when the spool is in the second position.

2. The three-way valve of claim 1 wherein the spool and valve body are configured block the flow path between the first port in the valve body to a second port in the valve body before defining the flow path between the first port and the poppet valve seat.

3. The valve of claim 1 wherein the poppet valve seat has an inner diameter equal to the spool valve bore diameter and a poppet valve seat angle differing from an angle of the poppet valve so that the poppet valve seats on the inner diameter of the poppet valve seat.

4. The valve of claim 1 further comprised of a solenoid actuator for moving the spool to the second position and a return spring disposed to encourage the spool to the first position.

5. A three-way ball valve comprising:
a ball;
first and second coaxial valve seats, the ball being moveable by a ball actuation member between a first position wherein the ball is on the first valve seat and a second position wherein the ball is on the second seat, the first seat being coupled to a source of fluid under pressure, the second seat being coupled to a vent, and a region surrounding the ball between the two seats being coupled to a region in which the pressure is to be controlled;
a valve actuation member disposed to be forced against the ball to force the ball from the second position to the first position, the valve actuation member having a land thereon fitting within a bore coaxial with the second seat to allow flow through the second seat when the ball is in the first position, and to prevent flow through the second seat when the ball is between the first and second positions.

6. The valve of claim 5 wherein the valve actuation member is hydraulically actuated.

7. The valve of claim 5 wherein the ball is surrounded by an orificed spacer between the first and second seats, the orificed spacer having a circular cylindrical opening surrounding the ball and providing a restriction in flow area between the ball and the orificed spacer.

8. The valve of claim 7 further comprising:
a valve body having a spool valve bore diameter with a poppet valve seat disposed at one end thereof;
a spool within the valve body, the spool having a poppet valve thereon, the spool being moveable within the valve body between a first position with the poppet valve positioned on the poppet valve seat and a second position with the poppet valve displaced from the poppet valve seat, the valve body and the spool defining a flow path between a first port in the valve body to a second port in the valve body when the spool is in the first position, and defining a flow path between the first port and the poppet valve seat and preventing flow between the first port and the second port when the spool is in the second position;
one of the second port and the valve seat being coupled to hydraulically actuate the valve actuation member.

9. The valve of claim 8 wherein the poppet valve seat has an inner diameter equal to the spool valve bore diameter and a poppet valve seat angle differing from an angle of the poppet valve so that the poppet valve seats on the inner diameter of the poppet valve seat.

10. The valve of claim 8 further comprised of a solenoid actuator for moving the spool to the second position and a return spring disposed to encourage the spool to the first position.

11. A three-way ball valve comprising:
a ball;
first and second coaxial valve seats, the ball being moveable by a valve actuation member between a first position wherein the ball is on the first valve seat and a second position wherein the ball is on the second seat, the first seat being coupled to a source of fluid under pressure, the second seat being coupled to a vent, and a region surrounding the ball between the two seats being coupled to a region in which the pressure is to be controlled;
an orificed spacer between the first and second seats, the orificed spacer having a circular cylindrical opening surrounding the ball and providing a restriction in flow area between the ball and the orificed spacer.

12. The valve of claim 11 wherein the valve actuation member is hydraulically actuated.

13. The valve of claim 12 further comprising:
a valve body having a spool valve bore diameter with a poppet valve seat disposed at one end thereof;
a spool within the valve body, the spool having a poppet valve thereon, the spool being moveable within the valve body between a first position with the poppet valve positioned on the poppet valve seat and a second position with the poppet valve displaced from the poppet valve seat, the valve body and the spool defining a flow path between a first port in the valve body to a second port in the valve body when the spool is in the first position, and defining a flow path between the first port and the poppet valve seat and preventing flow between the first port and the second port when the spool is in the second position;
one of the second port and the valve seat being coupled to hydraulically actuate the valve actuation member.

14. The valve of claim 13 wherein the poppet valve seat has an inner diameter equal to the spool valve bore diameter and a poppet valve seat angle differing from an angle of the poppet valve so that the poppet valve seats on the inner diameter of the poppet valve seat.

15. The valve of claim 13 further comprised of a solenoid actuator for moving the spool to the second position and a return spring disposed to encourage the spool to the first position.

16. A fuel injector for coupling to a fuel rail under pressure and to a vent comprising:
an intensifier having relatively large and small intensifier pistons;
a first three-way spool poppet valve having:
a valve body having a spool valve bore diameter with a poppet valve seat disposed at one end thereof;
a spool within the valve body, the spool having a poppet valve thereon, the spool being moveable within the valve body between a first position with the poppet valve positioned on the poppet valve seat and a second position with the poppet valve displaced from the poppet valve seat, the valve body and the spool defining a flow path between a first port in the valve body and a second port in the valve body when the spool is in the first position, and defining a flow path between the first port and the poppet valve seat and preventing flow between the first port and the second port when the spool is in the second position, the second port for coupling to a source fuel rail under pressure and the poppet valve seat for coupling to a vent;
a three-way ball valve having:
a ball;
first and second coaxial valve seats, the ball being moveable between a first position wherein the ball is on the first valve seat and a second position wherein the ball is on the second seat, the first seat being coupled to a source of fluid under pressure, the second seat being coupled to a vent, and a region surrounding the ball between the two seats being coupled to a region over the large intensifier piston;
a valve actuation member disposed to be hydraulically forced against the ball by fluid pressure from the second port of the three-way spool poppet valve to force the ball from the second position to the first position, the valve actuation member having a land thereon fitting within a bore coaxial with the second seat to allow flow through the second seat when the ball is in the first position, and to prevent flow through the second seat when the ball is between the first and second positions.

17. The fuel injector of claim 16 wherein the poppet valve seat has an inner diameter equal to the spool valve bore diameter and a poppet valve seat angle differing from an angle of the poppet valve so that the poppet valve seats on the inner diameter of the poppet valve seat.

18. The fuel injector of claim 16 wherein the ball is surrounded by an orificed spacer between the first and second seats, the orificed spacer having a circular cylindrical opening surrounding the ball and providing a restriction in flow area between the ball and the orificed spacer.

19. The fuel injector of claim 16 further comprised of a solenoid actuator for moving the spool to the second position and a return spring disposed to encourage the spool to the first position.

20. The fuel injector of claim 16 further comprising:
a needle;
a hydraulic actuator disposed to hold the needle closed when pressurized;
a second three-way spool poppet valve having:
a valve body having a spool valve bore diameter with a poppet valve seat disposed at one end thereof;
a spool within the valve body, the spool having a poppet valve thereon, the spool being moveable within the valve body between a first position with the poppet valve positioned on the poppet valve seat and a second position with the poppet valve displaced from the poppet valve seat, the valve body and the spool defining a flow path between a first port in the valve body and a second port in the valve body when the spool is in the first position, and defining a flow path between the first port and the poppet valve seat and preventing flow between the first port and the second port when the spool is in the second position, the second port of the second three-way spool poppet valve being coupled to the second port of the first three-way spool poppet valve, the first port of the second three-way spool poppet valve being coupled to the hydraulic actuator and the valve seat of the second three-way spool poppet valve being coupled to a drain.

21. The fuel injector of claim 20 further comprised of a first solenoid actuator for moving the spool of the first three-way spool poppet valve to the second position and a first return spring disposed to encourage the spool to the first position, and a second solenoid actuator for moving the spool of the second three-way spool poppet valve to the second position and a second return spring disposed to encourage the spool to the first position.

22. The fuel injector of claim 21 wherein the ball is surrounded by an orificed spacer between the first and second seats, the orificed spacer having a circular cylindrical opening surrounding the ball and providing a restriction in flow area between the ball and the orificed spacer.
